(19) United States
(12) Patent Application Publication
(10) Pub. No.: US 2006/0180506 A1
(43) Pub. Date: Aug. 17, 2006

(54) Screen apparatus

(75) Inventor: Yoshihiko Aikawa, Shizuoka (JP)

Correspondence Address: KANESAKA BERNER AND PARTNERS LLP, SUITE 300, 1700 DIAGONAL RD, ALEXANDRIA, VA, 22314-2848, US

(73) Assignee: AIKAWA IRON WORKS CO., LETD., Shizuoka (JP)

(21) Appl. No.: 11/172,907

(22) Filed: Jul. 5, 2005

(30) Foreign Application Priority Data
Dec. 15, 2004 (JP) 2004-362758

(51) Int. Cl. B07B 1/20; D21C 9/08

(52) U.S. Cl. 209/306; 162/55

(57) ABSTRACT

A screen apparatus for separating a foreign material from a papermaking material includes a tank for receiving the papermaking material; a screen dividing the tank into a primary chamber and a secondary chamber, a papermaking material supply passage for supplying the papermaking material into the tank, a foreign material discharge passage for discharging the foreign material in the papermaking material, a papermaking material discharge passage for discharging the papermaking material passing through the screen, a foil disposed in the primary chamber for stirring the papermaking material, and a dilute water introducing passage for introducing dilute water into the primary chamber. The dilute water introducing passage has a tip end tilted toward a rotational center of the foil in a direction that the foil rotates. The dilute water introducing passage has a tip opening section at the tip end facing a side of the foil.

### BACKGROUND OF THE INVENTION AND RELATED ART STATEMENT

The present invention relates to a screen apparatus, and more particularly, to a screen apparatus capable of improving screen cleaning effect to efficiently reduce clogging of a screen.

In a screen apparatus, a foil is positioned on an inner side of the screen, and a papermaking material is stirred by the foil, so that good fibers in the papermaking material pass through the screen and are separated from foreign materials not passing through the screen (see, for example, Patent Reference Patent Reference 1: Japanese Patent Publication (Kokai) No. 2004-137621

In the screen apparatus described above, when the papermaking material is cleaned, water is discharged from the screen along with fibers with time. Accordingly, a concentration of the papermaking material increases toward a downstream side in a flow of the papermaking material within the screen. For this reason, water is supplied into the screen via a water supply passage to reduce the concentration of the papermaking material, thereby preventing clogging of the screen. However, it is necessary to improve screen cleaning effect.

In view of the problems described above, an object of the present invention is to provide a screen apparatus with improved screen cleaning effect.

Further objects and advantages of the invention will be apparent from the following description of the invention.

### SUMMARY OF THE INVENTION

In order to achieve the objects described above, according to a first aspect of the present invention, a screen apparatus comprises a tank for receiving a papermaking material; a screen for dividing the tank into a primary chamber and a secondary chamber; a papermaking material supply passage connected to the primary chamber of the tank for supplying the papermaking material into the tank; a foreign material discharge passage connected to the primary chamber for discharging the papermaking material not passing through the screen and including foreign materials from the tank; a papermaking material discharge passage connected to the secondary chamber for discharging the papermaking material passing through the screen from the tank; a foil disposed in the primary chamber inside the screen for rotating and stirring the papermaking material in the primary chamber; and a dilute water introducing passage for introducing dilute water into the primary chamber. The dilute water introducing passage is tilted at least on a tip end thereof toward a rotational center of the foil in a direction that the foil rotates. The tip opening section faces a side of the foil rotating from a front edge to a rear edge where the dilute water is supplied.

According to a second aspect of the present invention, in the screen apparatus in the first aspect, the dilute water introducing passage has a first passage fastened to the tank so that one end thereof is situated outside the tank, the other end thereof is situated inside the tank, and a mid section thereof penetrates through the tank; and a second passage having one end connected to the other end of the first passage and the other end with a tip opening section facing the side of the foil from the front edge to the rear edge on the side that the dilute water is supplied. The screen is a tubular member having a ring section at a middle portion thereof. The second passage is disposed at the ring section, and the screen disposed in the tank so that an axis thereof extends vertically. The one end of the second passage has a second curved surface formed in an arc-shaped curved surface at a portion of a periphery of the screen. The other end of the first passage has a first curved surface formed in an arc-shaped curved surface contacting the second curved surface.

According to the screen apparatus in the first aspect, at least, the tip end of the dilute water introducing passage is tilted in the rotational direction of the foil toward the rotational center of the foil. Accordingly, the dilute water is introduced in a direction opposite to the rotational direction of the foil, thereby reducing a rotation rate of the papermaking material, so that a difference between the rotation rates of the foil and the papermaking material is increased. As a result in the primary chamber, a pressure at a location near openings of the screen where the foil passes becomes greater than that in the secondary chamber. Accordingly, a reverse flow of the papermaking material passing through the screen increases by an amount corresponding to the difference between the rotation rates of the foil and the papermaking material, thereby improving cleaning effect of the screen and effectively reducing clogging of the screen.

According to the screen apparatus in the second aspect in addition to the effects of the first aspect, the one end of the first passage has the first curved surface formed in the arc-shaped curved surface contacting the second curved surface of the second passage. That is, the first passage and the second passage of the dilute water introducing passage are separated. Accordingly, it is possible to move the screen in a vertical direction, while leaving the first passage as it is. Therefore, it is easy to perform maintenance and replacement of the screen.

### BRIEF DESCRIPTION OF THE DRAWINGS

FIG. 1 is a sectional view of a screen apparatus according to an embodiment of the present invention;

FIG. 2 is a sectional view of the screen apparatus taken along line 2-2 in FIG. 1;

FIG. 3 is a partially enlarged sectional view of a portion of the screen apparatus shown in FIG. 1;

FIG. 4 is a partially enlarged sectional view of a portion of the screen apparatus shown in FIG. 2;

FIG. 5 is an exploded sectional view of the screen apparatus shown in FIG. 1;

FIG. 6 is a sectional view of the screen apparatus taken along line 6-6 in FIG. 5;

FIG. 7 is an exploded view of a portion of the screen apparatus shown in FIG. 5;

FIG. 8 is a sectional view corresponding to FIG. 2 showing a screen apparatus according to another embodiment of the present invention; and

FIG. 9 is a partially enlarged sectional view of a portion of the screen apparatus shown in FIG. 8.

### DETAILED DESCRIPTION OF PREFERRED EMBODIMENTS

Hereunder, embodiments of the present invention will be explained with reference to the accompanying drawings.

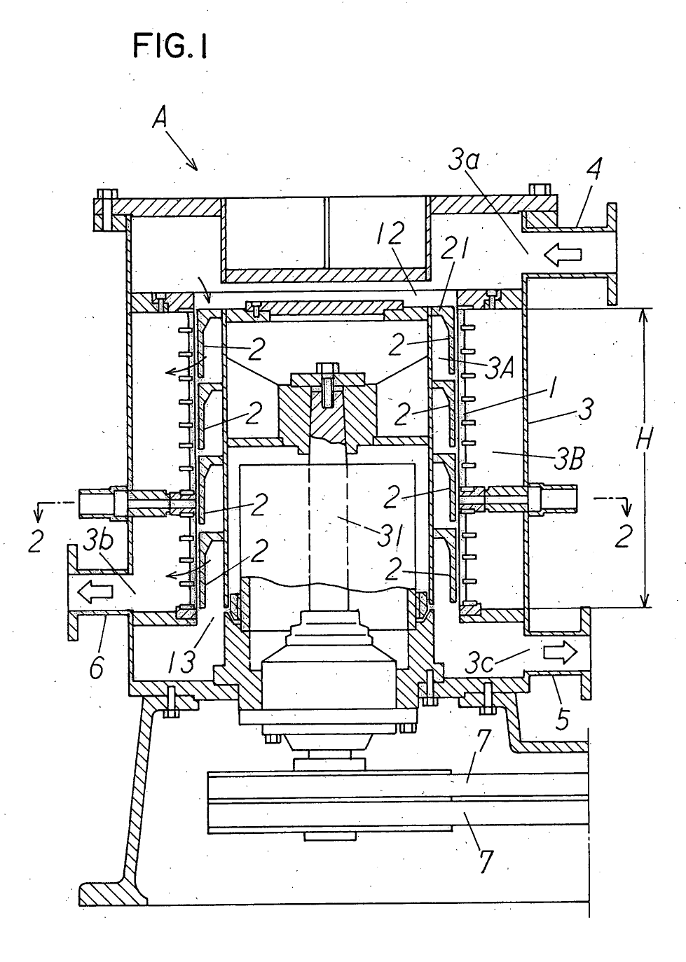

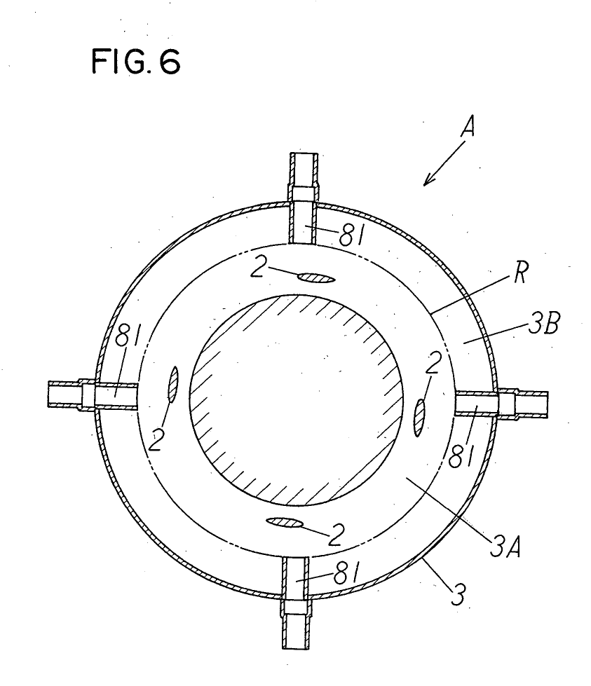

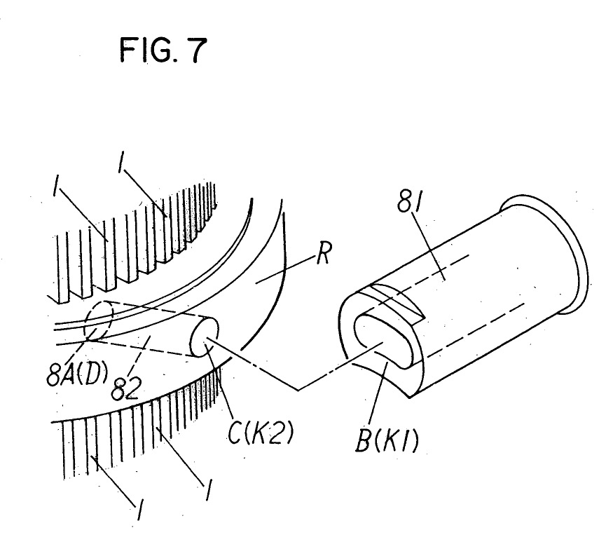

In FIGS. 1 to 7, reference A represents a screen apparatus, and the screen apparatus A is configured to continuously remove foreign materials from a papermaking material by, separating fibers from the foreign materials and cleaning a screen 1 by rotating foils 2 disposed inside the screen 1 to oppose one another.

The screen 1 and the foils 2 are disposed within a tank 3 which receives the papermaking material. The tank 3 is divided by the screen 1 into a primary chamber 3A and a secondary chamber 3B. The tank 3 has a supply port 3a to receive the papermaking material; a papermaking material discharge port 3b to discharge the papermaking material passing through the screen 1 from the tank 3; and a foreign material discharge port 3c to discharge the papermaking material not passing through the screen 1 and containing the foreign materials.

Reference numeral 4 represents a papermaking supply passage connected to the primary chamber 3A for supplying the papermaking material to the tank 3. Reference numeral 5 represents a foreign material discharge passage connected to the primary chamber 3A for discharging the papermaking material not passing through the screen 1 and containing the foreign materials from the tank 3. Reference numeral 6 is a papermaking material discharge passage connected to the secondary chamber 3B for discharging the papermaking material passing through the screen 1.

The screen 1 has a tubular shape, and a plurality of openings 11 in a side surface thereof. The openings 11 are, for example, holes, slits (elongated rectangular gaps), or gaps created by bar-shaped longitudinal members that are annularly arranged so as to leave gaps (longitudinal gaps) between the members. The screen 1 is fastened upright in the tank 3 with a ceiling section 12 and a bottom section 13 open.

The foils 2 are disposed in the primary chamber 3A, i.e., inside the screen 1, so as to, rotate freely and stir the papermaking material within the primary chamber 3A. The foils 2 overhang and drop down at plural locations from a ceiling and a side of a disc-shaped member 21 connected to a rotation shaft 31 disposed within the tank 3. The foils 2 are provided at multiple locations. In this embodiment, the foils 2 are provided at four levels four pieces at each level. The foils 2 are disposed at multiple levels, and may be provided at one level and extend out from the ceiling of the disc-shaped member 21 and drop down in elongated shapes (not shown). The foils 2 are rotated by a motor (not shown) via a power transmission member 7 (a belt, for example).

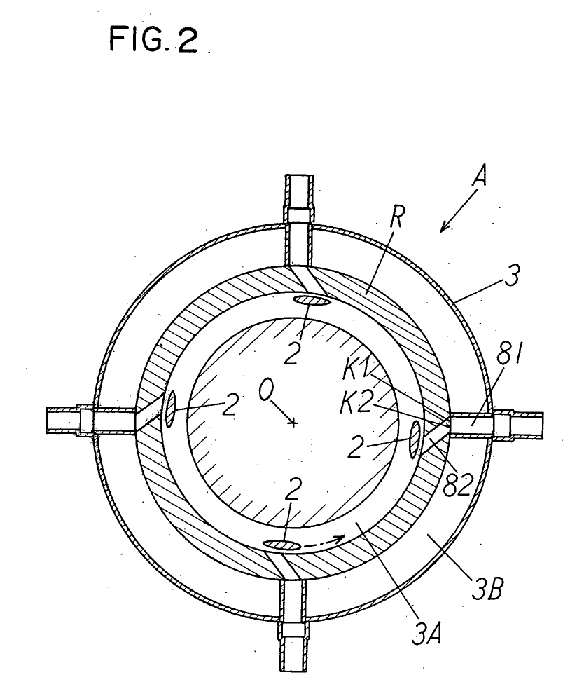

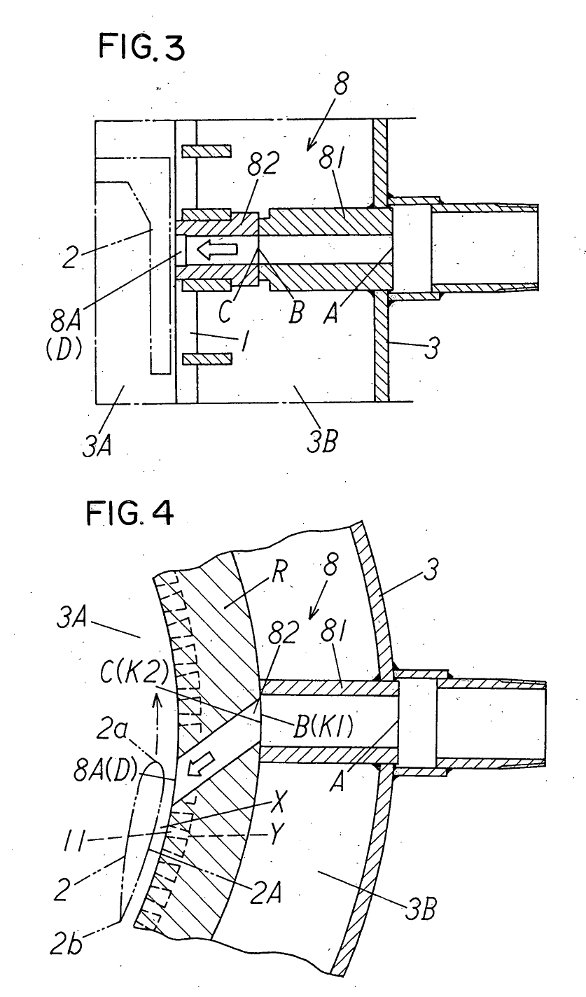

Reference numeral 8 is dilute water introducing passages for introducing dilute water into the primary chamber 3A. A tip side of the dilute water introducing passage 8 is tilted in a direction of the rotation of the foil 2 as it approaches a rotational center 0 of the foil 2. (see FIG. 2). A tip end of the dilute water introducing passage 8 is open to form a tip opening section 8A (see FIGS. 3 and 4). Each of the tip opening sections 8A faces an edge 2A of the foil 2 on the dilute water side which spans from a front edge 2a to a rear edge 2b (see FIG. 4).

Each of the dilute water introducing passages 8 has a first passage 81 and a second passage 82. The first passage 81 is fixed (welded, for example) to the tank 3, so that one end A of the first passage 81 is situated outside the tank 3, the other end B of the first passage 81 is situated inside the tank 3, and a mid section of the first passage 81 penetrates through the tank 3 (see FIGS. 3 and 4).

One end C of the second passage 82 is connected to the end B of the first passage 81, and the other end D (tip opening section 8A) faces the edge 2A of the foil 2 on the dilute water side which spans from the front edge 2a to the rear edge 2b. The dilute water introducing passages 8 are preferably positioned at, one half of a height H of the screen 1 or lower.

The screen 1 described above is a tubular member and has a ring section R in the middle. The second passages 82 are disposed in the ring section R, and the screen 1 is disposed in the tank 3, so that an axis thereof extends vertically. The end C of the second passage 82 has a second curved surface K2 formed in an arc-shaped curved surface that is a portion of the periphery of the screen 1. The end B of the first passage 81 has a first curved surface K1 formed in an arc-shaped curved surface so as to abut against the second curved surface K2.

The tip sides of the dilute water introducing passages 8 are tilted in the rotational direction of the foil 2 toward the rotational center of the foil 2. Accordingly, the dilute water is introduced in the reverse direction of the rotation of the foil 2 to slow the rotation rate of the papermaking material. As a result, the difference, between the rotation rates of the foil 2 and the papermaking material is increased. This temporarily provides a higher pressure at a location X in the primary chamber 3A (see FIG. 4) near one of the openings 11 of the screen 1 where the foil 2 passes than at a location Y in the secondary chamber 3B, thereby increasing the reverse flow of the papermaking material passing through the screen 1 by an amount corresponding to the increased difference between the rotation rates of the foil 2 and the papermaking material. Accordingly, it is possible to improve cleaning operation of the screen 1 and effectively reduce clogging of the screen 1.

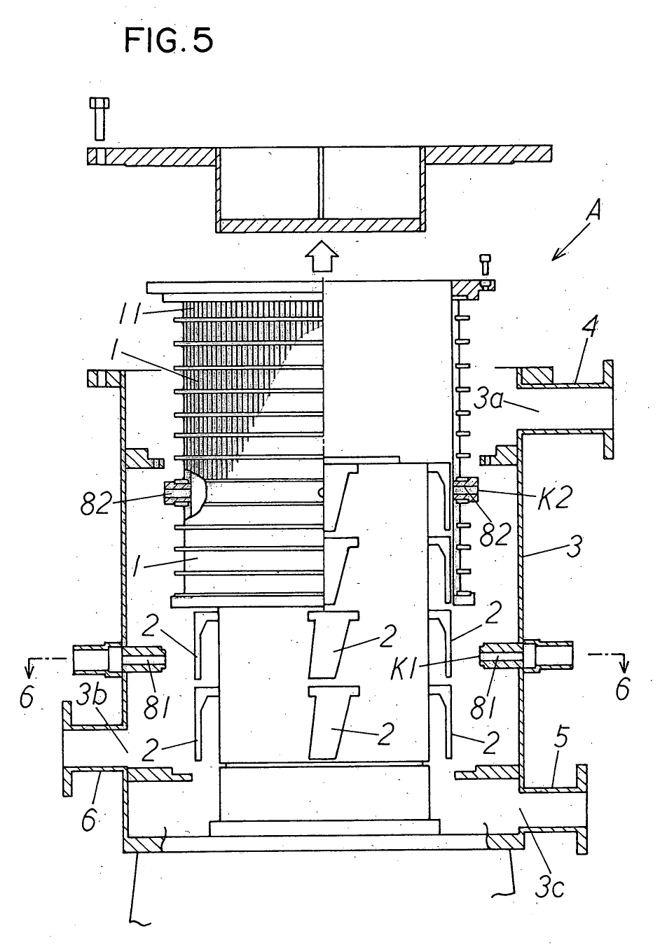

The other end B of the first passage 81 has the first curved surface K1 formed in the arc-shaped curved surface so as to abut against the second curved surface K2 of the second passage 82, i.e., the first passage 81 and the second passage 82 of the dilute water introducing passage 8 are separated. Therefore, the screen 1 can be moved in the perpendicular direction, while leaving the first passage 81 as it is, as shown in FIG. 5, for easy maintenance or replacement of the screen 1.

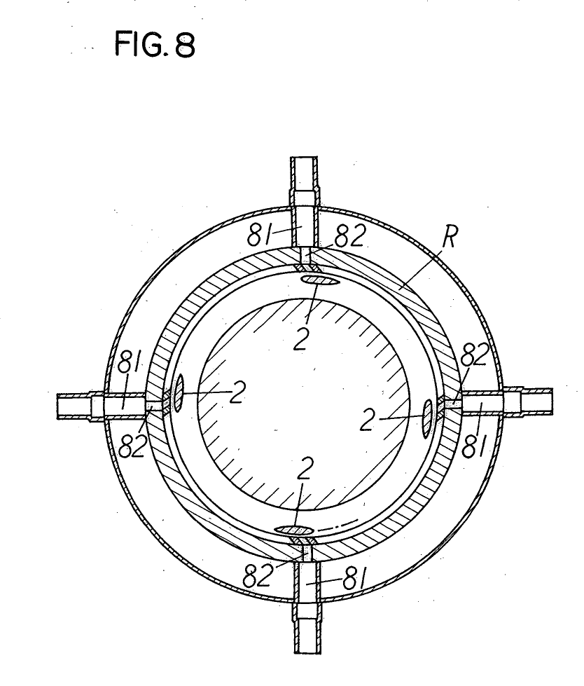

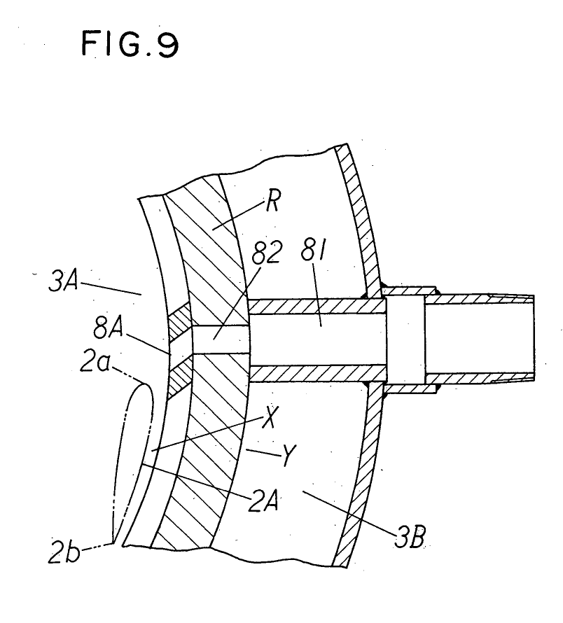

In the embodiments described above, the second passages 82 are tilted entirely in the ring section R, and only the side located near the tip opening section 8A may be tilted, as shown in FIGS. 8 and 9. In the dilute water introducing passages 8, it is necessary to tilt at least the tip ends thereof in the rotational direction of the foil 2 toward the rotational center of the foil 2.

The disclosure of Japanese Patent Application No. 2004-362758, filed on Dec. 15, 2004, is incorporated in the application.

While the invention has been explained with reference to the specific embodiments of the invention, the explanation is illustrative and the invention is limited only by the appended claims.

What is claimed is:

1. A screen apparatus for separating a foreign material from a papermaking material, comprising:
a tank for receiving the papermaking material,
a screen situated in the tank for dividing the tank into a primary chamber and a secondary chamber,
a papermaking material supply passage connected to the primary chamber for supplying the papermaking material into the tank,
a foreign material discharge passage connected to the primary chamber for discharging the papermaking material not passing through the screen and containing the foreign material from the tank,
a papermaking material discharge passage connected to the secondary chamber for discharging the papermaking material passing through the screen from the tank,
a foil disposed in the primary chamber for rotating and stirring the papermaking material in the primary chamber, and
a dilute water introducing passage for introducing dilute water into the primary chamber, said dilute water introducing passage having a tip end tilted toward a rotational center of the foil in a direction that the foil rotates, said dilute water introducing passage having a tip opening section at the tip end facing a side of the foil from a front edge to a rear edge where the dilute water is supplied.

2. A screen apparatus according to claim 1, wherein said dilute water introducing passage includes a portion tilted relative to the rotational center of the foil in a direction opposing rotation of the foil.

3. A screen apparatus according to claim 2, wherein said dilute water introducing passage includes a first passage fastened to the tank and having one end situated outside the tank, the other end situated inside the tank, and a mid section penetrating through the tank, and a second passage having one end connected to the other end of the first passage and the other end with the tip opening section.

4. A screen apparatus according to claim 3, wherein said second passage forms said portion tilted relative to the rotational center.

5. A screen apparatus according to claim 3, wherein said screen has a tubular shape with an axis extending vertically, and a ring section at a middle thereof, said second passage being disposed in the ring section.

6. A screen apparatus according to claim 5, wherein said first passage includes a first curved surface at the other end thereof, said second passage having a second curved surface at the one end thereof contacting the first curved surface.

7. A screen apparatus according to claim 1, wherein said foil is disposed inside the screen.
